(19) United States
(12) Patent Application Publication
(10) Pub. No.: US 2025/0237332 A1
(43) Pub. Date: Jul. 24, 2025

(54) AIR CONDITIONING SERVICE ADAPTER

(71) Applicant: Schrader-Bridgeport International, Inc., Altavista, VA (US)

(72) Inventor: Major H. Gilbert, Gladys, VA (US)

(73) Assignee: Schrader-Bridgeport International, Inc., Altavista, VA (US)

(21) Appl. No.: 18/415,978

(22) Filed: Jan. 18, 2024

(51) Int. Cl. F16L 21/00; B60H 1/00

(52) U.S. Cl. CPC F16L 21/002; B60H 1/00585

(57) ABSTRACT

An adapter that provides fluid communication to an air conditioning system, such as in a vehicle, is disclosed. The adapter includes a housing defining an internal passageway and a valve core positioned within the internal passageway. The valve core is movable between an open and closed state to control fluid communication through the adapter. The adapter housing is configured with a tube side opening to receive a tube fitting of an AC system port. The adapter housing includes a circumferential seal positioned within the adapter housing to provide a fluid seal between the housing tube side opening and the tube fitting. A retention device or a deformable flange of the adapter housing may retain a shoulder of the tube fitting to couple the adapter with the tube fitting. The adapter may reduce the number of variants needed to connect to tube fittings of AC system ports and improve their universality.

### FIELD OF THE TECHNOLOGY

The present disclosure relates generally to devices and adapters for servicing air conditioning systems in automobiles and other applications.

### BACKGROUND

Air conditioning systems used in automobiles and other vehicles are serviced from time to time, which may include recharging the air conditioning system with additional or new refrigerant or repairing the air conditioning system. During such servicing, the refrigerant within the air conditioning system may be recovered so that it may be recycled or properly disposed of. A low-pressure tube fitting and high-pressure tube fitting of the air conditioning system permit access to the refrigerant contained therein. Depending on the vehicle and/or the air conditioning system, various sized and geometry low-pressure fittings and high-pressure fittings may be used. In addition, the tube fittings may include different internal geometry and/or different internal threading dimensions or features.

To connect to the air conditioning system, often times adapters are used to connect air conditioning servicing equipment to the low-pressure and high-pressure tube fittings of the air conditioning system. This permits recovery of the refrigerant contained within the air conditioning system and permits accurate recharging of vehicle air conditioning systems with new refrigerant. Because of the large number of variants of internal geometry and threading of air conditioning tube fittings, many different adapters are often necessary to accommodate different air conditioning systems, requiring a large inventor of adapters.

The embodiments described herein relate to improved adapter structures to improve the universality of adapters, reducing the number of variants necessary to manufacture and maintain in inventory, such as for servicing purposes.

### BRIEF DESCRIPTION OF THE DRAWINGS

The embodiments of the present disclosure may be better understood with reference to the following drawings and description. The components in the figures are not necessarily to scale, with emphasis instead placed upon illustrating the principles of the present disclosure. Moreover, in the figures, like reference numerals are generally used to designate similar or identical features.

FIGS. 1A-1B are cross-sectional views of a first embodiment of a low-pressure side adapter for servicing an air conditioning system in accordance with certain aspects of the present disclosure.

FIGS. 2A-2B are cross-sectional views of a second embodiment of a high-pressure side adapter for servicing an air conditioning system in accordance with certain aspects of the present disclosure.

FIG. 3 is an example embodiment of a retention device of the adapter of FIGS. 1A-1B and the adapter of FIGS. 2A-2B.

FIGS. 4A-4B are cross-sectional views of a third embodiment of a low-pressure side adapter for servicing an air conditioning system in accordance with certain aspects of the present disclosure.

FIGS. 5A-5B are cross-sectional views of a fourth embodiment of a high-pressure side adapter for servicing an air conditioning system in accordance with certain aspects of the present disclosure.

FIG. 6 is a cross-sectional view depicting the deformation of a deformable flange of the adapter of FIGS. 4A-4B and the adapter of FIGS. 5A-5B.

### DETAILED DESCRIPTION OF THE EMBODIMENTS

Various aspects of the present disclosure are described below with reference to the drawings. The relationship and functioning of the various elements may be better understood by reference to the following detailed description. However, aspects are not limited to those illustrated in the drawings or explicitly described below. It should be understood that the drawings are not necessarily to scale, and in certain instances, details may have been omitted that are not necessary for an understanding of aspects disclosed herein, such as conventional fabrication and assembly.

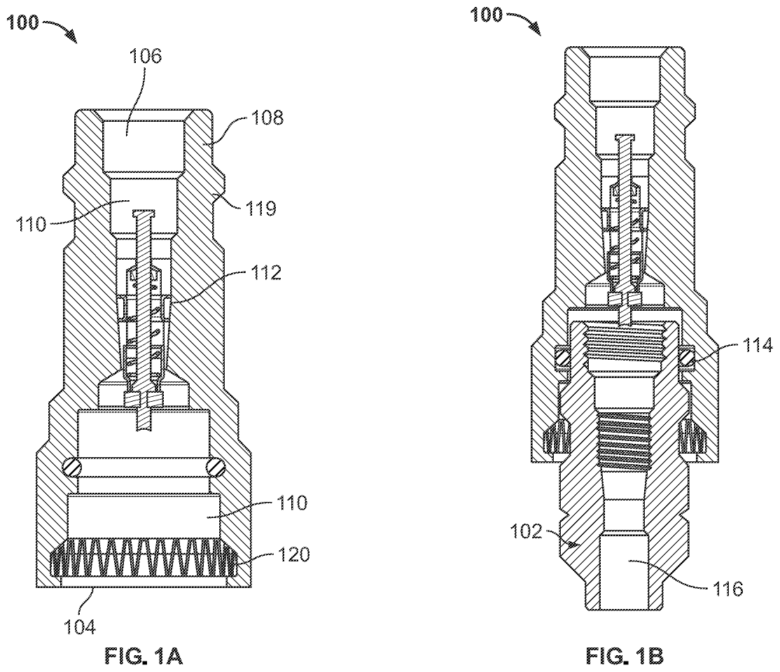

FIGS. 1A-1B depict a cross-sectional view of an adapter 100. In this disclosure, the adapter 100 is used to provide fluid communication with an air conditioning system (“AC system”) typically used in automobile or other vehicle applications, and more specifically, to a low-pressure side service port of the AC system. The adapter 100 may be used for any other suitable application.

In the depicted embodiment of FIGS. 1A-1B, the adapter 100 includes a service side 106 (also referred to as a service side opening 106) designed to couple to an air conditioning service system and an AC system side 104 (also referred to as a tube side opening 104) designed to couple to a tube fitting 102 of an air conditioning system, such as one of an automobile. The adapter 100 may be used to retrofit from a first refrigerant valve configuration to a second valve configuration. In some applications, this may include converting from a first Society of Automotive Engineers (SAE) standard valve configuration to a second SAE standard valve configuration. For example, the AC system side 104 of the adapter 100 may be configured to install onto an SAE type R-134a fitting in an AC system and convert to an SAE type R-1234yf fitting on service side 106. This may permit connection of servicing equipment to an AC system using an adapter 100, helping improve the universality of such connections.

When servicing an AC system, various equipment may be used, such as a refrigerant recovery machine. The refrigerant recovery machine is used to recover, evacuate, and recharge air conditioning system. The refrigerant recovery machine typically includes two service hoses. The service hoses are connected to a tube fitting of the AC system, such as the low-pressure side tube fitting 102. The low-pressure side tube fitting 102 may also be referred to as a low-pressure side port. The servicing hose usually contains a fitting designed to connect to the tube fitting 102 to permit access to the AC system and the refrigerant contained therein. However, in some instances, the service hose fitting of the refrigerant recovery machine may not be able to connect to the tube fitting 102. For example, the types of refrigerants used in AC systems may change as emissions and other regulatory controls evolve. As new refrigerants are used, the tube fittings (i.e., access ports) to the AC systems may also be changed to correspond with these new refrigerants. Accordingly, AC systems using old refrigerants and/or old tube fittings may coexist in the service field at the same time as AC systems using new refrigerants and/or new fittings. Refrigerant recovery machines may be designed with fittings that are only compatible with, for example, the new refrigerant fittings. But such refrigerant recovery machines may be used to service old refrigerant AC system, though its fitting size may not necessarily be compatible with the old fitting. Thus, an adapter, such as adapter 100, may need to be used to connect the refrigerant recovery machine to the AC system.

The adapter 100 includes an adapter housing 108. The adapter housing 108 may surround and define a fluid passageway 110 (also referred to as internal passageway 110). The fluid passageway 110 permits fluid communication between the AC system and servicing equipment (not shown). For example, the fluid passageway 110 may permit refrigerant to flow through adapter 100 from a service side 106 to AC system side 104. This may permit fluid communication between a refrigerant source used in servicing and the AC system of, for example, an automobile, as described previously.

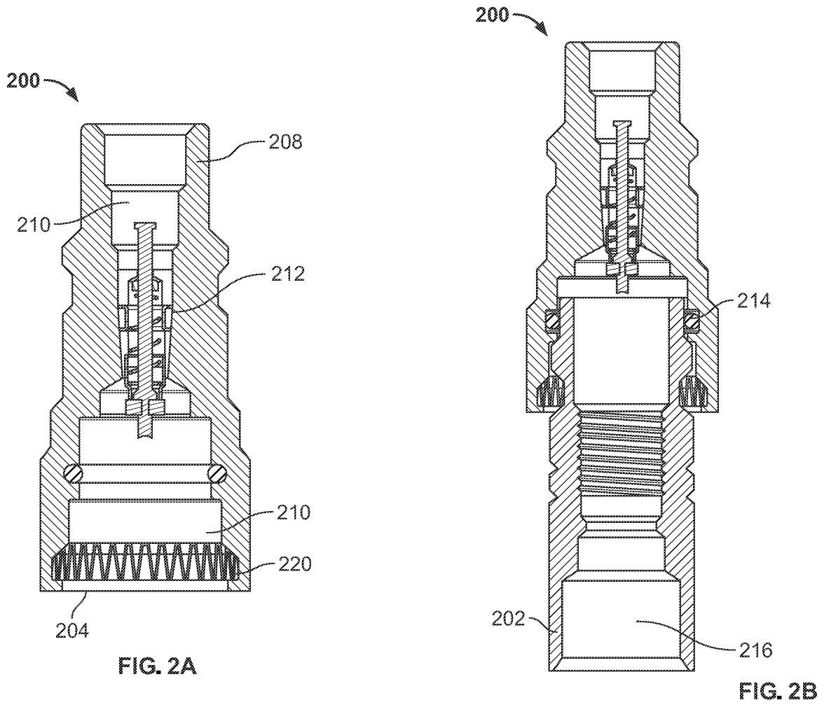

To control the fluid flow through adapter 100, adapter 100 may include a valve core 112. Valve core 112 may be formed of any suitable valve, for example, a stem valve core, JRA valve core, or standard core. The valve core 112 typically includes an external seal on the core, made of, for example neoprene, chloroprene, EPDM rubber, hydrogenated nitrile butadiene rubber (HNBR) or Teflon, to minimize or prevent leakage from the adapter 100. The type of valve core 112 may vary depending on whether it is used in a low-pressure application (e.g., adapter 100), or a high-pressure application (e.g., adapter 200, depicted in FIGS. 2A-2B), as some cores may permit higher flow or better robustness in the various applications. The valve core 112 is used to control the flow through adapter 100. The valve core 112 may be designed to restrict flow of fluid through the fluid passageway 110 of adapter 100 except when desired, for example, during recharging or servicing of the AC system. After the recharging or servicing of the AC system is complete, valve core 112 may seal such that no flow of fluid is permitted from the AC system side 104 to the service side 106 or vice versa.

Adapter 100 may also include an internal seal 114. The internal seal 114 may be positioned on the tube side opening 104 of the adapter housing 108 between the retention device 120 and the valve core 112. The internal seal 114 may be circumferential around the internal surface defined by the adapter housing 108. The internal seal 114 may be an elastomeric sealing device, such as an O-ring, butterfly ring, rectangular ring, or other suitable gasket. The internal seal 114 may be formed of any suitable material, for example, neoprene, chloroprene, EPDM rubber, or hydrogenated nitrile butadiene rubber (HNBR). The internal seal 114 may also be a formed from suitable sealants such as a silicone sealant. The internal seal 114 seals the adapter 100 to tube fitting 102. The internal seal 114 may provide a fluid seal between the tube fitting 102 and the adapter housing 108. This may assist in preventing any fluid in the AC system from leaking out of the joining of the fluid passageway 110 of adapter 100 and tube fitting 102. Internal seal 114 may ensure that refrigerant or other fluid flowing through fitting fluid passageway 116 also flows through fluid passageway 110 when the valve core is open, and vice versa, such that no fluid is lost during recovery and recharging of an AC system.

Though not depicted in FIGS. 1A-1B, adapter 100 may also include an external sealing cap. The external sealing cap may be installed on the service side 106 of the adapter 100 after the AC system has been serviced, for example, after recovery and recharging of the AC system. The external sealing cap may include an internal seal such that when it is installed onto adapter 100, it forms a fluid-tight seal. The external sealing cap may be installed onto the adapter 100 to cap-off the system and provide a secondary seal to prevent leakage of any fluid from the AC system that is within fluid passageway 110 and past the primary seal of the valve core 112. The external sealing cap may be attached to the adapter 100 via a retainable shoulder 119 on the adapter housing 108, threads on the interior or exterior of the housing, or any other suitable means. The retainable shoulder 119 may also provide a retaining surface for connecting servicing equipment to the adapter 100.

FIGS. 2A-2B depict a cross-sectional view of another embodiment of an adapter 200 and tube fitting 202, and more specifically, an adapter configured to couple with a high-pressure side service tube fitting of an AC system. The high-pressure side adapter 200 may be similar to that of low-pressure side adapter 100. In some examples, high-pressure side adapter 200 may be the same as the low-pressure side adapter 100 except for the geometry, such as the diameter of the fluid passageway 210 and the external dimensions of the adapter housing 208. For example, similar to the low-pressure side adapter 100, high-pressure side adapter 200 includes a service side 206 and an AC system side 204, a fluid passageway 210 connecting the two sides via a valve core 212 to control the flow of fluid.

In many applications, the high-pressure side, an example of which is shown in FIGS. 2A-2B, is used to evacuate and fill the AC system in an assembly plant, while the low-pressure side, an example of which is shown in FIGS. 1A-1B, are used to evaluate and fill the AC system in service conditions. However, in some applications, the AC system is evacuated and/or filled from the low-pressure service side in the assembly plant, shown in FIGS. 1A-1B.

In conventional AC service systems, a refrigerant recovery machine may be designed to connect to the AC system through internal features of tube fitting 102 and tube fitting 202, such as internal threads. While the external geometry of tube fitting 102 and/or tube fitting 202 may be provided for by various requirements, such as an SAE (Society of Automotive Engineers) standard, the internal features of such tube fittings often vary widely based on system. For example, tube fitting 102 and/or tube fitting 202 may have any variety of short threads, long threads, screw threads, square threads, rounded threads, straight threads, tapered threads, and/or any variety of internal diameters. In conventional AC service systems, adapters are used to connect the refrigerant recover machine or other service system to the tube fittings of the AC system via the internal mating features of a tube fitting. Because of the wide variety of different internal mating features of the tube fittings, a wide variety of adapters are typically needed to ensure that different AC systems can be serviced. This requires the manufacture, supply, and storage in inventory of a large number of adapters. Needing a large number of adapters in inventory for manufacturers and/or service providers makes it difficult to ensure that a wide variety of AC systems can be connected to for filling and/or recharging. Adapter 100 and adapter 200 overcome such deficiencies by connecting to external features of tube fitting 102 and tube fitting 202 of an AC system. Because the external features of tube fitting 102 and tube fitting 202 are often standard between various AC systems, only a single adapter 100 and adapter 200 can provide a more universal adapter and replace what could be tens of conventional adapters. The adapter 100 and adapter 200 permit conversion of the external geometry of the tube fitting 102 and tube fitting 202 to another external geometry of the service side 106 and service side 206. This permits manufacturers and/or service providers to maintain inventory of fewer adapters and provide servicing to a wider variety of AC systems. This may also provide manufacturers and/or service providers to service older AC systems with tube fittings that may otherwise be obsolete.

Adapter 100 may include a retention device 120 to secure the adapter 100 to tube fitting 102. The retention device 120 may be positioned within the fluid passageway 110 of the AC system side 104. The retention device 120 may be configured to retain a shoulder of the tube fitting 102 such that the tube fitting 102 is coupled to the adapter housing 108. The retention device 120 The retention device 120 may be configured to fit within a recessed or grooved portion of the tube fitting 102. The retention device 120 may be any suitable device, for example, a retention ring, snap ring, push-on ring, coupler, cone spring, or barbell spring. In some examples, the retention device 120 is formed by a disc spring or Belleville washer. The retention device 120 may be formed such that it permits relatively simple installation of the adapter 100 onto tube fitting 102, but requires significant effort or force to remove adapter 100 from tube fitting 102. This may be achieved by providing a conical shape to retention device 120, wherein the wider end is peripheral to narrower end, i.e., the wider end is close to the exterior of adapter housing 108. This permits the tube fitting 102 to slide through the wider end of the retention device 120 while being retained by the narrower end of the retention device 120. The retention device 120 may be slotted so that it is flexible, permitting the retention device 120 to expand when adapter 100 is installed, such that it narrows and retains tube fitting 102 when fully installed. In some examples, retention device 120 permits the adapter 100 to rotate with respect to the tube fitting 102 along its center axis (i.e., the axis of fluid passageway 110).

In some examples, adapter housing 108 may include two or more flat exterior surfaces such that a wrench or other suitable tool may be used to hold and/or rotate the adapter 100 relative to tube fitting 102. These surfaces may be opposing. This may assist, for example, in securing equipment to adapter 100 for servicing the AC system or for installing an external sealing cap after servicing the AC system.

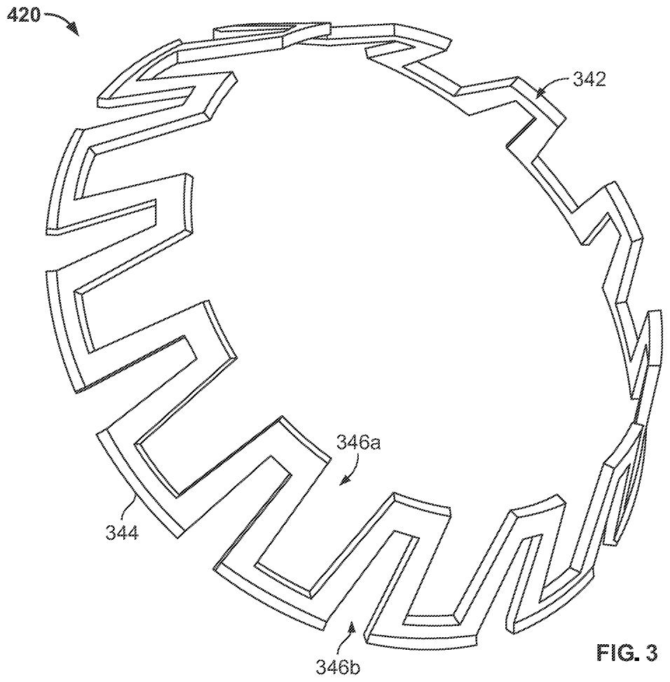

FIG. 3 is an example embodiment of a retention device 320. The retention device 320 may be used with a low-pressure side adapter, as with reference to FIGS. 1A-1B, and/or a high-pressure side adapter, as with reference to FIGS. 2A-2B. The retention device 320 may have a general frusto-conical shape. This includes a top circular plane 342 and a bottom circular plane 344. The top circular plane 342 may be a smaller diameter than the bottom circular plane 344. The material forming the retention device 320 may form a generally circular path that alternates between the top circular plane 342 and the bottom circular plane 344 forming the frusto-conical shape of retention device 320. In some examples, this material may include a generally square-wave shape, a sine-wave shape, a triangle-wave shape, or other suitable pattern. The retention device 320 may be formed of any suitable metallic material or alloy, or plastic material. The retention device includes open portions 346a and 346b between the alternating or oscillating portions. This, along with the material of the retention device 320 permits the retention device 320 to flex. The retention device 320 may generally expand in the radial direction when receiving a fitting, such as a tube fitting. Once the tube fitting is received, the retention device 320 may return to its original shape, retaining the tube fitting. The bottom circular plane 344 may be sufficiently large to fit over a shoulder of the tube fitting, while the top circular plane 342 may be smaller than the shoulder, such that it expands when it slides over the tube fitting should and then returns to a smaller diameter after it slides past the shoulder, thus retaining the tube fitting to the adapter.

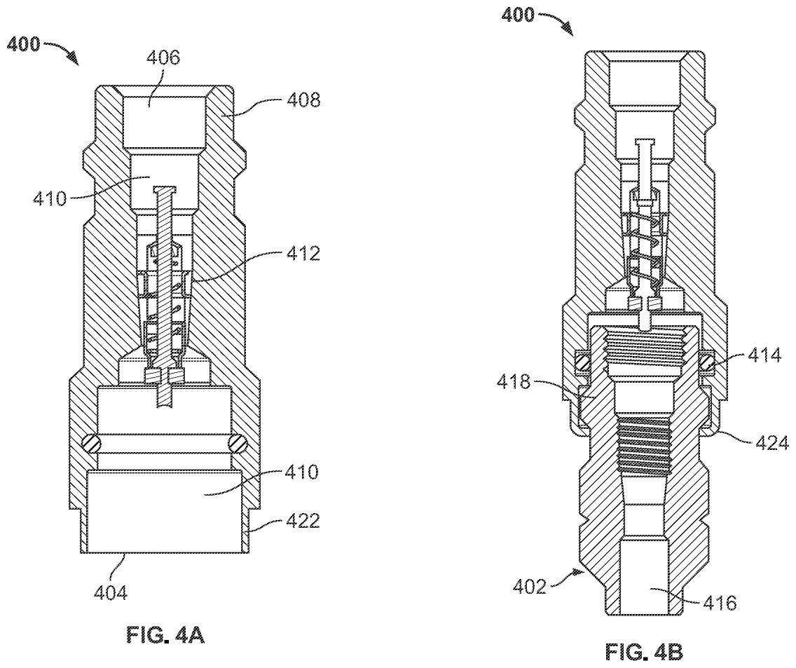

FIGS. 4A-4B depict cross-sectional views of yet another adapter 400 and service tube fitting 402, and more specifically, an adapter configured to couple with a low-pressure side service tube fitting of an AC system. Adapter 400 may include a deformable flange 422. The deformable flange 422 may define a recess that surrounds the fitting housing 418 to receive the tube fitting 402 in adapter 400. The deformable flange 422 is dimensioned such that it surrounds tube fitting 402. Upon receiving the tube fitting 402 within the recess of the deformable flange 422, the deformable flange 422 may be crimped or otherwise deformed such that it forms a crimp seal 424. A roll forming tool or crimping tool may be used to create crimp seal 424. In some examples, deformable flange 422 includes raised portions such as knurling, ridges, or other suitable shape such that when the deformable flange 422 is shaped around the shoulder of tube fitting 402, the raised portions provide additional gripping and joint strength to crimp seal 424. Crimp seal 424 may deform around a shoulder or other raised portion of tube fitting 402 to couple adapter 400 to tube fitting 402. Crimp seal 424 may prevent rotation of adapter 400 relative to tube fitting 402. A portion of the deformable flange 422 may extend past the shoulder or other raised portion of tube fitting 402 to provide additional stability to the joint.

Adapter 400 may also include an internal seal 414. The internal seal 414 may be circumferential around the internal surface defined by the adapter housing 408. The internal seal 414 may be positioned on the tube side opening 404 (i.e., AC system side 404) of the adapter housing 408 between the deformable flange 422 and the valve core 412. The internal seal 414 may be an elastomeric sealing device, such as an O-ring, butterfly ring, rectangular ring, or other suitable gasket. The internal seal 414 may be formed of any suitable material, for example, neoprene, chloroprene, EPDM rubber, or hydrogenated nitrile butadiene rubber (HNBR). The internal seal 414 may also be a formed from suitable sealants such as a silicone sealant. The internal seal 414 seals the adapter 400 to tube fitting 402. The internal seal 414 may provide a fluid seal between the tube fitting 402 and the adapter housing 408. This may assist in preventing any fluid in the AC system from leaking out of the joining of the fluid passageway 410 of adapter 400 and tube fitting 402. Internal seal 414 may ensure that refrigerant or other fluid flowing through fitting fluid passageway 416 also flows through fluid passageway 410 when the valve core is open, and vice versa, such that no fluid is lost during recovery and recharging of an AC system.

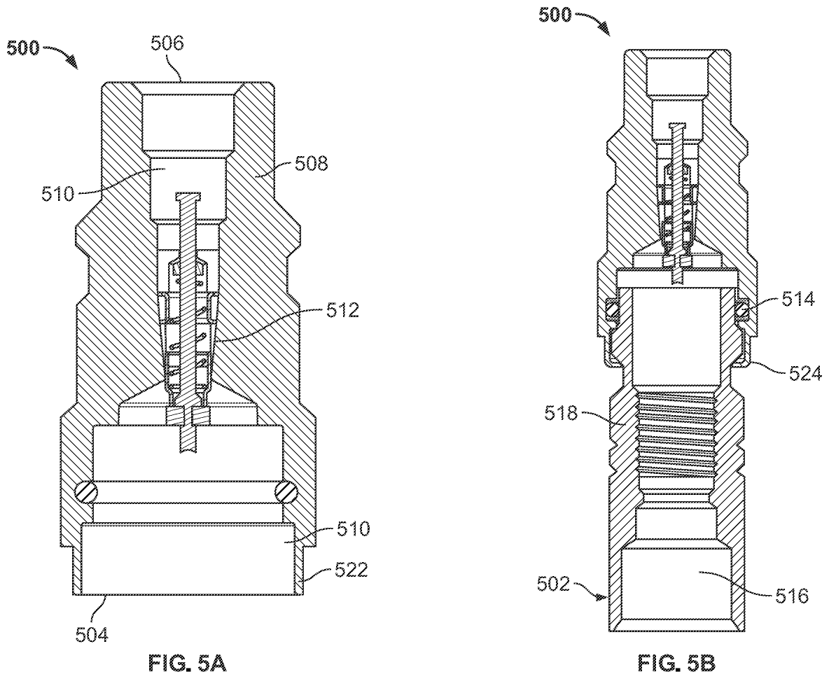

FIGS. 5A-5B depict cross-sectional views of still another adapter 500 and service tube fitting 502, and more specifically, an adapter configured to couple with a high-pressure side service tube fitting of an AC system. The high-pressure side adapter 500 may be similar to that of low-pressure side adapter 400. In some examples, high-pressure side adapter 500 may be the same as the low-pressure side adapter 400 except for the geometry, such as the diameter of the fluid passageway 510 and the external dimensions of the adapter housing 508. For example, similar to the low-pressure side adapter 400, high-pressure side adapter 500 includes a service side 506 and an AC system side 504, a fluid passageway 510 connecting the two sides via a valve core 512 to control the flow of fluid. The adapter 500 also includes a deformable flange 522. The deformable flange 522 may define a recess that surrounds the fitting housing 518 to receive the fitting 502 in adapter 500. The deformable flange 522 may be formed to create crimp seal 524. Crimp seal 524 may deform around a shoulder or other raised portion of fitting 502 to couple adapter 500 to fitting 502.

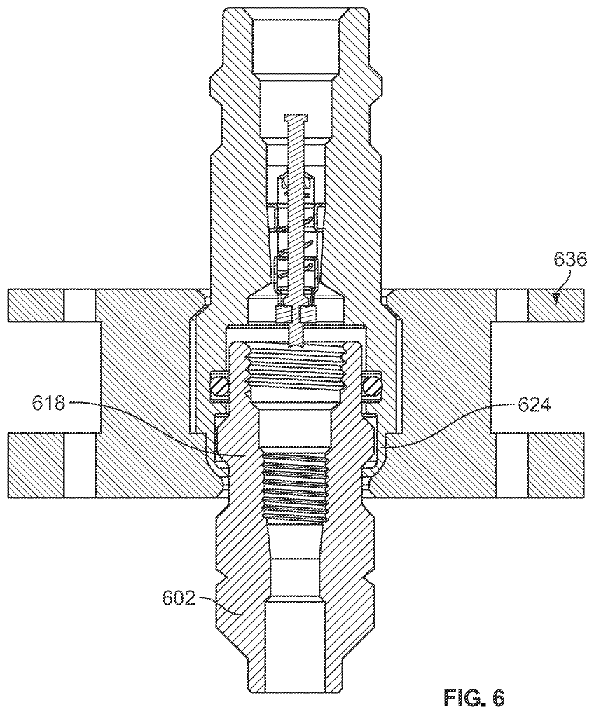

FIG. 6 is a cross-sectional view depicting an example deformation of a deformable flange of the adapter of FIGS. 4A-4B and the adapter of FIGS. 5A-5B. The deformable flange of the adapter 600 may be deformed using a crimping tool 636. The crimping tool 636 may engage with the adapter 600 such that it is in contact with the deformable flange. Upon squeezing the tool 636, the tool 636 may deform the deformable flange to create the crimp seal 624. The tool 636 may be used to create crimp seal 624 formed around a shoulder 618 of the tube fitting 602. The crimp seal 624 may then retain the tube fitting 602 in the adapter 600.

Many other modifications of the embodiments above may be made to adapt a particular situation or material to the teachings without departing from the scope of the current disclosure. Therefore, it is intended that the present devices and systems not be limited to the particular embodiments disclosed, but that the disclosed devices and systems include all embodiments falling within the scope of the appended claims. Moreover, the advantages described herein are not necessarily the only advantages of the present disclosure and it is not necessarily expected that every embodiment of the present disclosure will achieve all of the advantages described.

1. (canceled)

2. (canceled)

3. (canceled)

4. (canceled)

5. (canceled)

6. (canceled)

7. (canceled)

8. (canceled)

9. (canceled)

10. An adapter comprising:
an adapter housing defining an internal passageway permitting fluid communication through a tube side opening and a service side opening of the adapter housing, wherein the tube side opening is adapted to receive a tube fitting;
a valve core positioned within the internal passageway and between the tube side opening and the service side opening, wherein the valve core is movable between an open state and a closed state, wherein the tube side opening is in fluid communication with the service side opening when the valve core is in the open state, and wherein the valve core prevents fluid communication between the tube side opening and the service side opening when the valve core is in a closed state;
wherein the housing further comprises:
a deformable flange on the tube side of the housing, wherein the deformable flange is configured to be deformed over a shoulder of the tube fitting to couple the tube fitting to the housing; and
a circumferential seal positioned on the tube side of the housing between the deformable flange and the valve core, wherein the circumferential seal is configured to provide a fluid seal between the tube fitting and the housing.

11. The adapter of claim 10, wherein the circumferential seal is made of an elastomeric material.

12. The adapter of claim 11, wherein the circumferential seal is one of an O-ring, butterfly ring, or rectangular ring.

13. The adapter of claim 10, wherein the adapter housing further comprises a pair of opposing flat surfaces positioned on an exterior surface of the adapter housing.

14. The adapter of claim 10, wherein the adapter housing further comprises a retainable shoulder on an exterior surface of the service side of the housing.

15. The adapter of claim 10, wherein the deformable flange further comprises raised portions configured to grip the tube fitting.

16. The adapter of claim 15, wherein the raised portions are knurls.

17. The adapter of claim 10, wherein the deformable flange further comprises an elongate portion that extends past the shoulder of the tube fitting when the deformable flange is deformed and is configured to provide stability to the coupling of the tube fitting to the housing.

18. The adapter of claim 10, further comprising an external sealing cap comprising an internal seal configured to provide a fluid seal between the external sealing cap and the adapter housing.

19. The adapter of claim 18, the adapter housing further comprising an external thread on the service side, the external sealing cap comprising an internal thread on an internal surface of the external sealing cap, wherein the internal thread of the external sealing cap is configured to engage the external thread of the adapter housing to secure the external sealing cap to the adapter.

20. The adapter of claim 18, the adapter housing further comprising a retainable shoulder on an exterior surface of the service side of the housing, wherein the external cap is configured to engage the retainable shoulder to secure the external sealing cap to the adapter.

21. The adapter of claim 10, wherein a length of the deformable flange is sized to extend past the shoulder of the tube fitting before the deformable flange is deformed.

22. An adapter comprising:
an adapter housing defining an internal passageway permitting fluid communication through a tube side opening and a service side opening of the adapter housing, wherein the tube side opening is adapted to receive a tube fitting; and
a valve core positioned within the internal passageway and between the tube side opening and the service side opening, wherein the valve core is movable between an open state and a closed state, wherein the tube side opening is in fluid communication with the service side opening when the valve core is in the open state, and wherein the valve core prevents fluid communication between the tube side opening and the service side opening when the valve core is in a closed state;
wherein the housing further comprises:
a deformable flange on the tube side of the housing comprising an elongate portion that extends past a shoulder of the tube fitting when the deformable flange is deformed, wherein the deformable flange is configured to be deformed over a shoulder of the tube fitting to couple the tube fitting to the housing and the elongate portion is configured to provide stability to the coupling of the tube fitting to the housing; and
a circumferential seal positioned on the tube side of the housing between the deformable flange and the valve core, wherein the circumferential seal is configured to provide a fluid seal between the tube fitting and the housing.

23. The adapter of claim 22, wherein the adapter housing further comprises a retainable shoulder on an exterior surface of the service side of the housing.

24. The adapter of claim 22, further comprising an external sealing cap comprising an internal seal configured to provide a fluid seal between the external sealing cap and the adapter housing.

25. The adapter of claim 24, the adapter housing further comprising an external thread on the service side, the external sealing cap comprising an internal thread on an internal surface of the external sealing cap, wherein the internal thread of the external sealing cap is configured to engage the external thread of the adapter housing to secure the external sealing cap to the adapter.

26. An adapter system comprising:
a first adapter connected to a high-pressure side of an automobile air conditioning system; and
a second adapter connected to a low-pressure side of the automobile air conditioning system;
wherein the first and the second adapter comprise:
an adapter housing defining an internal passageway permitting fluid communication through a tube side opening and a service side opening of the adapter housing, wherein the tube side opening is adapted to receive a tube fitting of the automobile air conditioning system; and
a valve core positioned within the internal passageway and between the tube side opening and the service side opening, wherein the valve core is movable between an open state and a closed state, wherein the tube side opening is in fluid communication with the service side opening when the valve core is in the open state, and wherein the valve core prevents fluid communication between the tube side opening and the service side opening when the valve core is in a closed state;
wherein the housing further comprises:
a deformable flange on the tube side of the housing, wherein the deformable flange is configured to be deformed over a shoulder of the tube fitting to couple the tube fitting to the housing; and
a circumferential seal positioned on the tube side of the housing between the deformable flange and the valve core, wherein the circumferential seal is configured to provide a fluid seal between the tube fitting and the housing.

27. The adapter of claim 26, wherein the deformable flange further comprises an elongate portion that extends past the shoulder of the tube fitting when the deformable flange is deformed and is configured to provide stability to the coupling of the tube fitting to the housing.

28. The adapter of claim 26, further comprising an external sealing cap comprising an internal seal configured to provide a fluid seal between the external sealing cap and the adapter housing.

29. The adapter of claim 28, the adapter housing further comprising an external thread on the service side, the external sealing cap comprising an internal thread on an internal surface of the external sealing cap, wherein the internal thread of the external sealing cap is configured to engage the external thread of the adapter housing to secure the external sealing cap to the adapter.
